(19) United States
(12) Patent Application Publication
(10) Pub. No.: US 2026/0357105 A1
(43) Pub. Date: Nov. 12, 2026

(54) ULTRAVIOLET AND EROSION RESISTANT, WHITE POLYURETHANE COATING FOR AN AIRCRAFT EXTERNAL SURFACE

(71) Applicant: The Patent Well LLC, Fort Worth, TX (US)

(72) Inventor: Troy E. Wiegand, Fort Worth, TX (US)

(21) Appl. No.: 19/657,544

(22) Filed: Apr. 24, 2026

Related U.S. Application Data
(60) Provisional application No. 63/801,625, filed on May 7, 2025.

(51) Int. Cl. C09D 175/04; B05D 1/28; B05D 3/10

(52) U.S. Cl. CPC C09D 175/04; B05D 1/28; B05D 3/108; B05D 2202/25; B05D 2503/00

(57) ABSTRACT

A polymer coating for application to the surface of an aircraft, or to an aircraft part, which protects the substrate surface from particulates or fluids, with improved erosion resistance and UV resistance. A two-component polyurethane coating adheres well to painted and primed surfaces and may be applied to vertical surfaces with no dripping or running. The coating may be clear, colorless, white or any other color. The coating may be an isocyanate and a polyol mix that cures to form a non-yellowing polyurethane coating with a tensile strength of greater than 600 psi, an elongation of 50% or more, and a hardness range of shore A 70 to 90, or alternately greater than 70. The uncured mix is applied to an aircraft surface, and allowed to cure.

### CROSS-REFERENCE TO RELATED APPLICATION

This application claims the benefit of U.S. Provisional Patent Application No. 63/801,625 filed May 7, 2025, which is hereby incorporated.

### BACKGROUND OF THE INVENTION

### Field of the Invention

Coatings for aircraft external surfaces, namely two-part, curable polymer coatings.

### Description of the Related Art

Due to the environment in which they are exposed, aircraft, especially the external surfaces thereof are subject to corrosion, wear and tear. Thus, specialized products are typically needed, those products that are sufficient for use in a normal terrestrial environment often being insufficient.

Polymer coatings have been developed, some of which are suitable to the temperature, pressure and humidity cycles that occur during an aircraft take off, climb to altitude and descent to landing.

### SUMMARY OF THE INVENTION

Applicant has developed a novel polymer coating for application to the surface of an aircraft, including the external surface thereof which polymer coating has novel properties designed to protect a substrate surface, especially a substrate surface exposed to impact from particulate or fluids matter including rain and dust.

In one aspect Applicant provides a two-component polyurethane coating designed for use as an erosion resistant, leading-edge protectant for aircraft. The coating adheres well to painted and primed surfaces and may be applied to vertical surfaces with no dripping or running. The coating may be clear, colorless, white or any other color.

In one non-limiting embodiment Applicant provides a coating comprising an isocyanate and a polyol mix that cures to form an ultraviolet resistant (non-yellowing) polyurethane coating with, in some embodiments, a tensile strength of greater than 600 psi (ASTM 412) and an elongation of 50% or more (ASTM D412), and a hardness range of shore A 70 to 90, or alternately greater than 70 (23° C @24 hours, ASTM D 2240).

In another non-limiting embodiment, Applicant provides a method of protecting an aircraft surface, the method, in some embodiments, comprising at least applying to an aircraft surface a mix comprising an isocyanate and a polyol, the isocyanate and polyol the mix capable of curing to form polyurethane coating with a minimum tensile strength of greater than 600 psi, and a minimum elongation of 50% or more and a hardness in the range of shore A 70 to 90 (or greater than 70); and allowing the mix to cure. The applying step may be performed with a brush, roller or any other suitable manner.

In another non-limiting embodiment, Applicant discloses aircraft assemblies typically comprising at least one of the following parts: a leading edge, an antenna, a galley seam, a lavatory seam, a cargo door, an entry door scuff plate, a canoe fairing; where at least some of the surface of the part is at least partially coated with a cured polyurethane coating, in some embodiments with a minimum tensile strength of at least 600 psi, a minimum elongation of 50%, and a hardness in the range of shore A 70 to 90 (or alternately greater than 70).

In another non-limiting embodiment, Applicant discloses an applicator for metering, mixing and dispensing a curable polymer mix, the applicator comprising: a first compartment having an isocyanate; a second compartment having a polyol; a forcing element in operative engagement with the first and second compartments; and, a mixing straw in fluid communication with the first and second compartments, wherein the polyol and isocyanate cure to form a polyurethane coating with a minimum tensile strength of 600 psi or more, a minimum elongation of 50%, and a hardness in the range of shore A 70 to 90 (or greater than 70).

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1 illustrates a cartridge for dispensing an uncured mix of Applicant’s coating in accordance with one implementation of the present invention;

FIG. 2A illustrates the cartridge with a forcing element engaged therewith in accordance with one implementation of the present invention;

FIG. 2B illustrates an uncured mix ready to be applied by brush to a substrate in accordance with one implementation of the present invention;

FIG. 3A illustrates Applicant’s mix applied to a canoe fairing (an aircraft part) in accordance with one implementation of the present invention;

FIG. 3B illustrates Applicant’s mix applied to an aircraft antenna in accordance with one implementation of the present invention;

FIG. 4 illustrates the storage and loss modulus, and tan deltas of two of Applicant’s mixes, as they change with time as the mix cures in accordance with one implementation of the present invention;

FIGS. 5A and 5B illustrate spray test and submersion results for the polyurethane mix for RD266 aircraft fluids in accordance with one implementation of the present invention;

FIG. 6 illustrates the change in loss and storage modulus as a function of time for the polyurethane mix, in accordance with one implementation of the present invention; and

FIG. 7 illustrates the peel strength data for the polyurethane mix on an Al 2024 coupon painted with BMS (Boeing Material Standard) paint in accordance with one implementation of the present invention.

The use of the same reference symbols in different drawings indicates similar or identical items.

### DESCRIPTION OF THE PREFERRED EMBODIMENT(S)

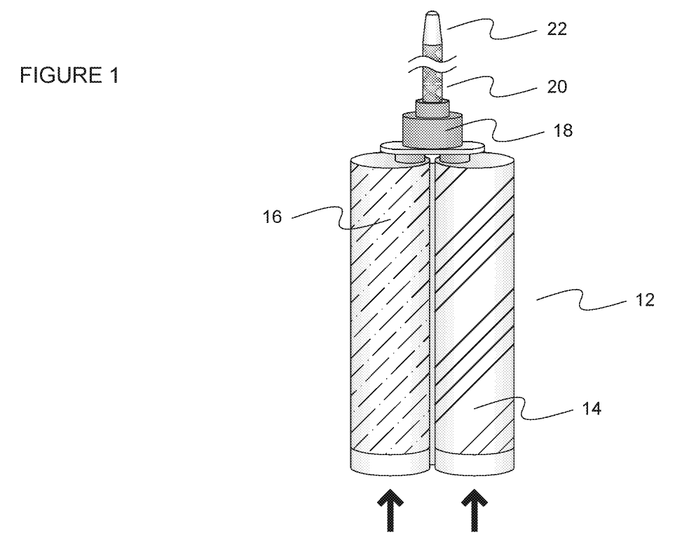

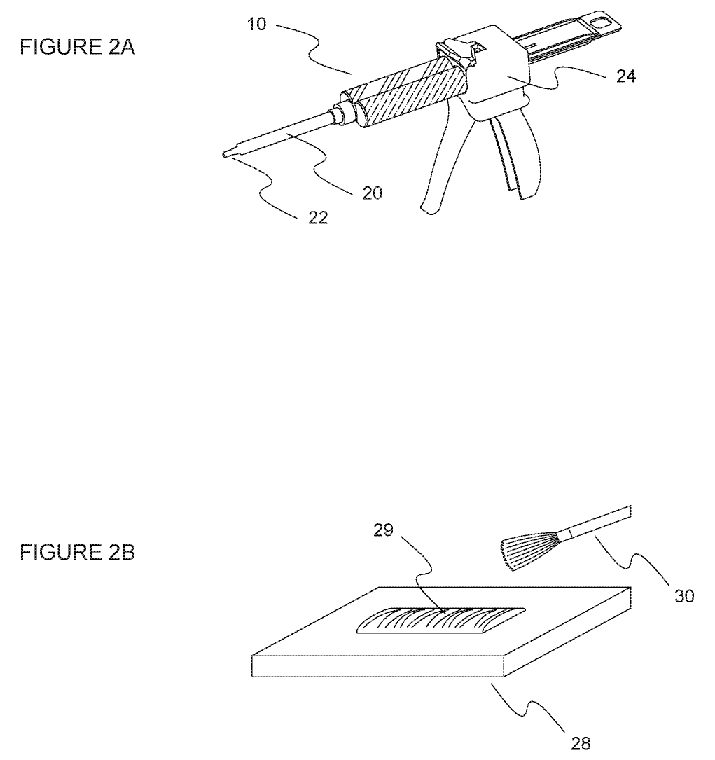

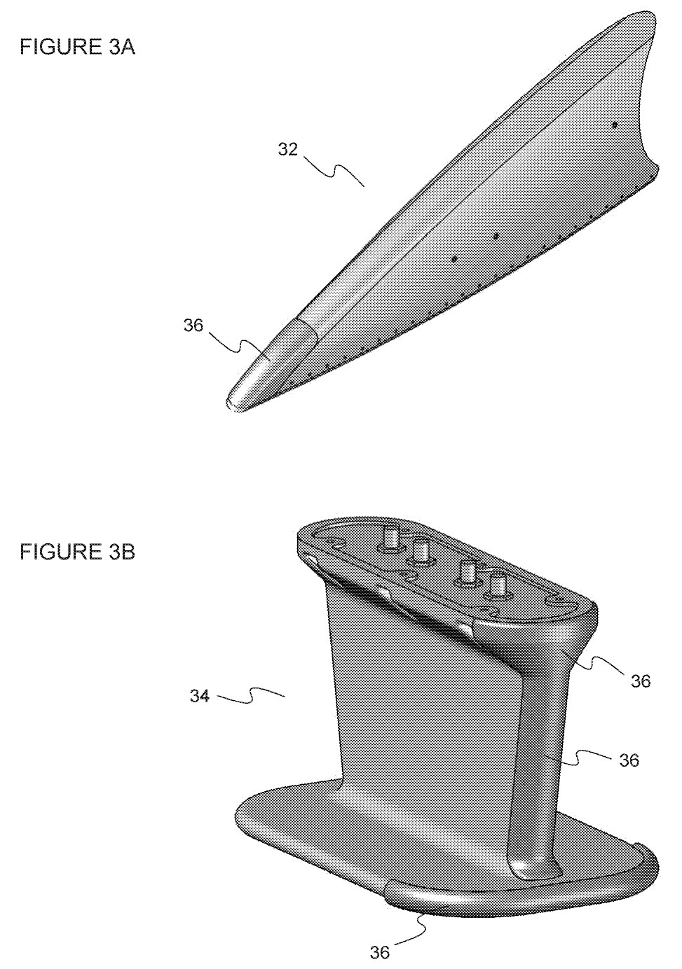

FIGS. 1 and 2A illustrate an injector assembly or applicator 10 (see FIG. 2A) including a cartridge body 12 having a first compartment 14 having either a polyol or an isocyanate and a second compartment 16 having the other of the polyol or isocyanate. The two compartments 14/16 are typically the same volume, in some embodiments 100 cc each (in other embodiments 25 cc each), adapted to receive a first component (polyol or isocyanate) and a second component of a mix which will cure into a cured polyurethane coating. The two components are forced into a mixing straw 20, which removable attaches to the cartridge 12 at connection member 18 placing the mixing straw in fluid communication with the first compartment and the second compartment. At the removed end of the mixing straw is a tip 22. Cartridge body 12 is adapted to receive a forcing assembly, see FIG. 2A. When the forcing assembly 24, which may be manually operated, see FIG. 2A, acts on the two compartments, the contents (polyol and isocyanate) are pushed into and through the mixing straw 26 and emitted as a viscous mix 26 directly onto a base 28 or other structure or substrate. A brush 30, such as an acid brush, is then used to transfer the mix 29 to an aircraft part, such as a canoe fairing 32, FIG. 3A or a entertainment Antenna 34, see FIG. 3B. The mix may be done with a brush, roller, or may be sprayed with a pneumatic spray gun with an applicator engaged therewith. Mixing may also be achieved by transferring the polyol and isocyanate from separate containers to a third and hand mix carefully so as not to entertain any bubbles.

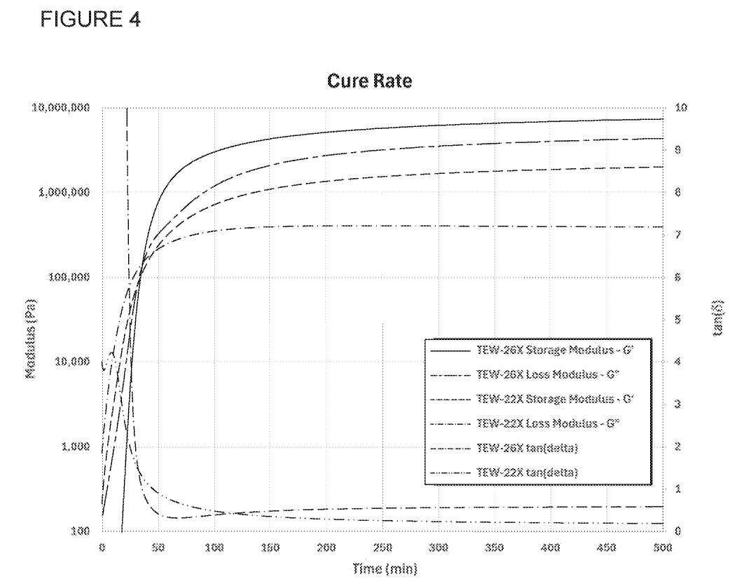

The mix should be applied before it is too thick to work with. This may be between 33% and 50% of the crossover time, or 10-25 min, see FIG. 4. Upon curing, the mix will form a polyurethane coating 36 with the properties set forth herein.

The cured polyurethane coat 36 has a variety of uses including in or on aircraft, such as where adjacent aircraft parts require erosion and impact resistance as well as corrosion protection. An aircraft assembly such as a canoe fairing 32 or an aircraft antenna 34 may have forward or leading edge portions exposed to wind, rain and air or water borne particulate matter, due to their forward facing position mounted on the exterior of the aircraft. FIG. 3A shows a dashed line designating a leading edge (high impact) area, wherein the shaded upper right (nose) portion has already been coated with the mix, transferred from the base via the brush, to the workpiece.

In some non-limiting embodiments Applicant’s coating comprises: an isocyanate and a polyol, the isocyanate and polyol forming a mix capable of curing to form a polyurethane coating with a minimum tensile strength of 600 psi, and minimum elongation of 50% and a hardness in the range of shore A 70 to 90 (or greater than 70). It may be clear, colorless, or have a color including white.

The polyurethane coating showed good particulate erosion resistance according to ASTM G76.

The polymer coating shows good UV resistance, as measured by accelerated exposure to controlled irradiance from xenon-arc apparatus (SAE J2527).

The polymer coating is relatively ductile and may be paintable on a primed or painted surface, with adhesion assessed by peel strength.

The polyurethane coating in some non-limiting embodiments reaches full cure between 2 hours and 8 hours, or about 5 hours as defined by rheometer data, (see FIG. 4) when the slopes of both the storage modulus and the loss modulus are approaching zero, or has reached 95% of its maximum physical properties. All rheological data from Anton Parr Model 302E , Force Normal=0, frequency=5Hz, Amplitude 1%-0.001% at a linearly decreasing rate.

The polymer coating may have a crossover time of 20 to 50 minutes. Crossover point is defined as the point in time at which the storage modulus is about equal to the loss modulus as tested with a rheometer during curing (see FIG. 4) as set forth herein.

The polymer coating on the isocyanate side may have a viscosity in the range of 35,000 to 65,000 cP prior to mixing. The polymer coating on the polyol side may have a viscosity in the range of 90,000 to 135,000 cP prior to mixing (23° C.).

The polymer may be used to protect an aircraft surface, the method by applying to an aircraft surface a mix comprising an isocyanate and a polyol, the isocyanate and polyol the mix capable of curing to form polyurethane coating with in some embodiments, one or more of the properties set forth in these specifications. In some embodiments the mix cures to a minimum tensile strength of 600 psi, and a minimum elongation of 50% and a hardness in the range of shore A 70 to 90 (or greater than 70). The aircraft surface is an external surface. The external surface may be a leading edge surface, namely any exterior surface of the aircraft that faces the airstream while in flight. The leading edge surface may be part of an antenna or antenna assembly such as an entertainment antenna (see FIG. 3A). The aircraft surface may also be a galley or lavatory seam, or other part subject to exposure to aircraft fluids. The aircraft surface may be an entry door scuff plate or cargo door frame. The aircraft surface may be a canoe fairing. In addition, landing gear doors as well as the landing gear parts, especially those subject runway debris are suitable places for the product. There are many other potential airframe applications that would be suitable for this coating, such as the leading edges of wings, vertical and horizontal stabilizers, landing gear doors, air ducts, drain masts, etc.

Side A may have a viscosity of between 117,110 and 120,200 cP at 23° C., Side B between 44,128 and 57,105 cP. A centrifugal mixer may be used to mix the ingredients on each side in ways known in the art.

The polyurethane mix sample (referred to by internal code TEW-265 in the drawings) cures in about 300 min, but provides a working life of 12-18 min (full cure about 300 min), the 220 has a working life of 15-23 min (full cure about 450 min) see FIG. 4. Working life begins at the time the sealant is first mixed to the time it is no longer usable because the setting mechanism has proceeded to the extent it is no longer workable. In some embodiments it is between 10 and 28 minutes. The polyurethane mix has a tensile strength of 681 +/- 72 psi, elongation of 77 +/-11% and hardness 77-83 Shore A.

Some properties may vary with the loading or presence of ingredients on either side. Color is imparted in some embodiments by the pigment chosen and loading. A colorless product results from no pigment whatsoever, a clear product results from omitting opaque pigments. Color change of the white polyurethane mix after exposure to UV per SAE J2725 is none to minimal. In some embodiments color may be designated by the following CIELab (ASTM D2244-23) for a white product, a L*a*b value of about 97.5* -1.1* 3.45.

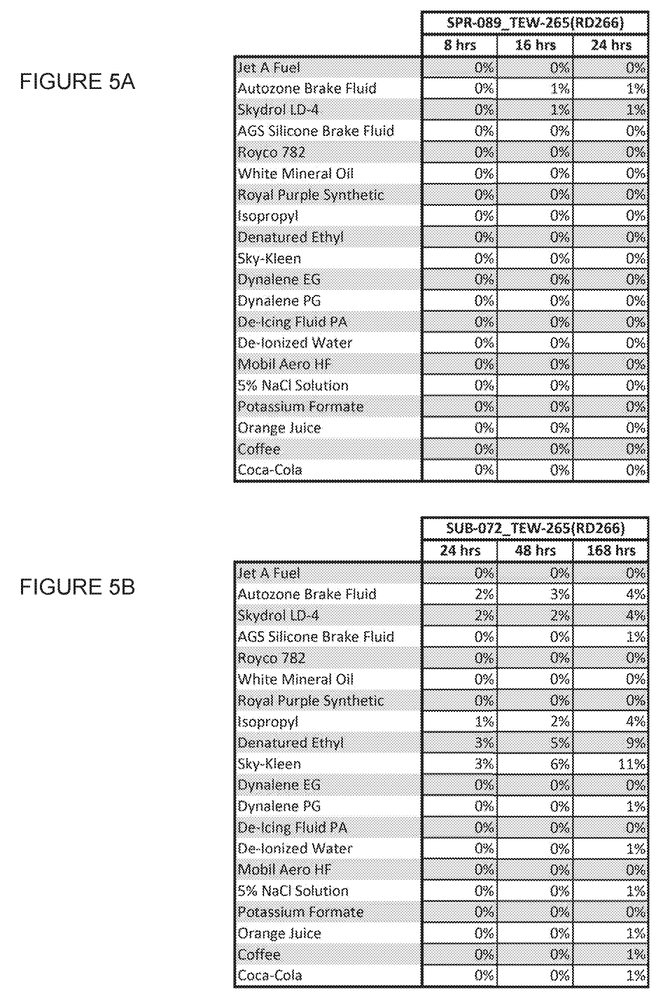

FIGS. 5A and 5B illustrate that the cured polyurethane mix coating shows good resistance to degradation in spray FIG. 5A or immersion FIG. 5B to common aircraft fluids (RD266 fluids).

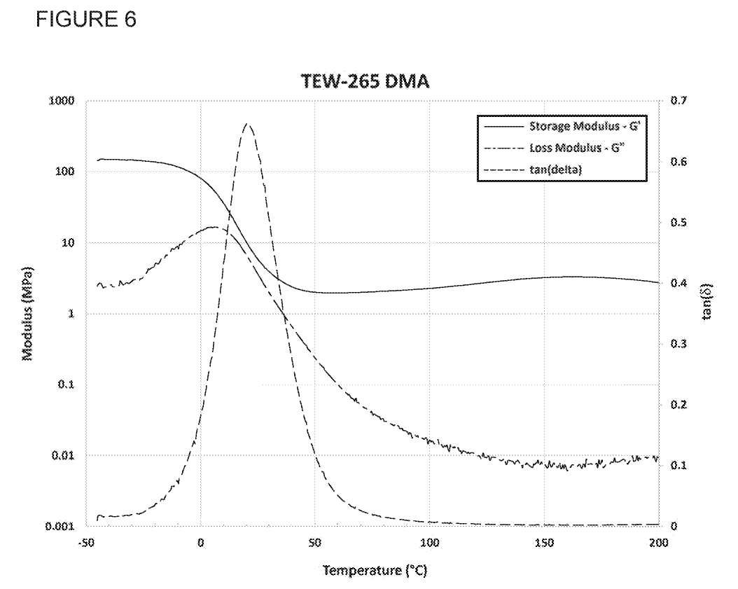

FIG. 6 illustrates the physical properties of the polyurethane mix measuring storage and loss modulus over a wide temperature range. The physical properties are continuous where G’ (storage modulus) is flat, in the rubbery plateau, above the Tg (23° C.). Entry into the flow region is not observed in FIG. 6, 200 °C. maximum, where there is slight discoloration. The continuous service temperature range is about -60 to 200° C.

Salt fog was tested using the following stack up: 2024 T3 clean bare coupon (if Alodined, Class 1A), primer 10P4-2NF, Topcoat BMS 10-72. After product removal from both painted and Alodined coupons show no corrosion (1000 hour ASTM B117).

Erosion testing was done pursuant to ASTM G76 3/4”x 3/4” specimen stack up same as salt fog (painted with BMS10-72 topcoat), 30° angle. Erodent discharge 5 gms/min, velocity 150 m/sec, duration 10 minutes, Alumina 50 microns erodent, ambient temp. Mass loss was 0.73% (product thickness about 60 mil), with 1% or less deemed satisfactory.

UV exposure was performed for 1000 hours with cured product on bare Al 2024 T3 on a rack and in a chamber (ASTM G7), with visible inspection showing no cracking, crazing or loss of adhesion, no yellowing and only very slight coloration change that may have been from a minor change in luster.

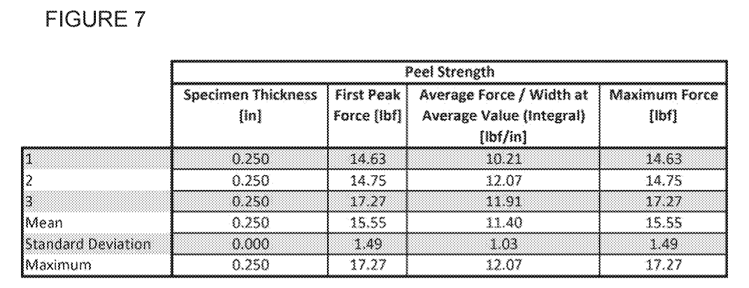

FIG. 7 shows peel strength of product cured for at least 24 hours at 23° C., from stack up as used for salt fog (product applied to BMS 10-47 topcoat), per ASTM D6862 (90° peel back). The product adheres well to a painted surface. The product passes the “cross-hatch” test, adhesion to scribed aluminum alloy, ASTM D 3359-23.

The cured product may be used on high erosion areas or the exterior of an aircraft, where after a period of time visual inspection if visual inspection shows some erosion, new product may be applied directly over the existing product.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A polymer coating for use on an aircraft surface, the coating comprising:
a polyurethane formed from the cured mix of an isocyanate and a polyol, the polyurethane coating with a minimum tensile strength of 600 psi, and minimum elongation of 50% and a hardness greater than shore A 70 and a weight loss of 1% or less (ASTM G76).

2. The polymer coating of claim 1 wherein the polyurethane coating is white.

3. The polymer coating of claim 1 wherein the polyurethane coating is impact resistant.

4. The polymer coating of claim 1 wherein the polyurethane coating is UV resistant, passing 1000 hours of exposure with a DE ⋜ 3.0 by SAE J2527.

5. The polymer coating of claim 1 wherein the polyurethane coating adheres well to a painted surface and passes the cross-hatch test (ASTM D3359-23).

6. The polymer coating of claim 1 where in the polyurethane coating reaches full cure between 2 hours and 8 hours, as defined by rheometry, when the slope of the curve for both the storage modulus and loss modulus approaches zero, or has reached 95% of its maximum physical properties.

7. The polymer coating of claim 1 where in the working life is between 10 and 28 minutes.

8. The polymer coating of claim 1 where in the isocyanate side has a viscosity in the range of 30,000 to 70,000 cP at a temperature of 25ºC and a shear rate of 0.174s⁻¹ , prior to mixing.

9. The polymer coating of claim 1 where in the polyol side has a viscosity in the range of 80,000 to 150,000 cP at a temperature of 25ºC and a shear rate of 0.174s⁻¹ , prior to mixing.

10. A method of protecting an aircraft surface, the method comprising:
applying to an aircraft surface a mix comprising an isocyanate and a polyol, the isocyanate and polyol the mix capable of curing to form polyurethane coating with a minimum tensile strength of 600 psi, and a minimum elongation of 50% and a hardness in the range of shore A 70 to 90, and a weight loss of 1% or less (ASTM G76); and
allowing the mix to cure.

11. The method of claim 10, wherein the aircraft surface is an external surface.

12. The method of claim 11, wherein the external surface is a leading edge surface.

13. The method of claim 12, wherein the leading edge surface is part of an antenna.

14. The method of claim 10 wherein the aircraft surface is part of an antenna assembly.

15. The method of claim 10 wherein the aircraft surface is a galley or lavatory seam.

16. The method of claim 10 wherein the aircraft surface is an entry door scuff plate or cargo door frame.

17. The method of claim 10 wherein the aircraft surface is a canoe fairing.

18. The method of claim 10 wherein the applying step is done with a brush, roller, or is sprayed.

19. The method of claim 10 further including mixing the isocyanate and polyol in a container.

20. The method of claim 19 wherein the applying step is performed at between 33% and 50% of the crossover time.

21. An aircraft assembly comprising at least one of the following parts:
a leading edge, an antenna, a galley seam, a lavatory seam, a cargo door, an entry door scuff plate, a canoe fairing;
wherein the part is at least partially coated with a polymer coating having a minimum tensile strength of 600 psi, a minimum elongation of 50%, and a hardness in the range of shore A 70 to 90, and weight loss 1% or less (ASTM G76).

22. An assembly for providing a curable polymer mix, the assembly comprising:
a body having a first compartment and a second compartment;
the first compartment containing an isocyanate;
the second compartment containing a polyol;
the body adapted to receive a forcing element in operative engagement with the first and second compartments; and
a mixing straw in fluid communication with the first and second compartments, wherein the polyol and isocyanate cure to form a polyurethane coating with a minimum tensile strength of 500 psi, a minimum elongation of 60%, and a hardness of at least Shore A 70 and a weight loss of 1% or less (ASTM G76).
